(19) United States
(12) Patent Application Publication
(10) Pub. No.: US 2003/0117708 A1
(43) Pub. Date: Jun. 26, 2003

(54) Sealed enclosure for a wire-grid polarizer and subassembly for a display system

(75) Inventor: Robert Harvey Kane, Ho-Ho-Kus, NJ (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/028,118

(22) Filed: Dec. 21, 2001

(51) Int. Cl. G02B 5/30; G02B 27/28; G02B 1/00

(52) U.S. Cl. 359/513; 359/486; 359/507

(57) ABSTRACT

The sensitive, active surface of a wire-grid polarizer is protected from degradation by ambient environments by incorporating the component in a non-reactive atmosphere maintained by a sealed enclosure. The enclosure may provide a unitary mounting system for the polarizer, a liquid crystal light modulation panel and a projection lens to form a last-stage sub-assembly for a projection display system.

### FIELD OF TH INVENTION

This invention relates to the protection of an environmentally-sensitive polarizer, and more particularly relates to a wire-grid polarizer for use in a display system employing a liquid crystal light modulator.

### BACKGROUND AND SUMMARY OF THE INVENTION

Display systems employing certain types of liquid crystal light modulators rely on a polarizing beam splitter (PBS) to direct input light of predominantly one polarization state to the light modulator panel. In particular, the type of light modulator (or light valve) known as a liquid crystal on silicon (LCoS) reflective device requires the illuminating beam to be linearly polarized.

The light modulator panel is composed of an array of individual picture elements or pixels defined by a reflective layer, a liquid crystal layer atop the reflective layer, and a row-and-column matrix of control electrodes. In one type of such a reflective liquid crystal light modulator panel, known as a liquid crystal on silicon (LCoS) panel, the control electrode circuitry is integrated into a silicon substrate below the reflective layer.

The polarization of the light incident on the array is altered on a pixel-by-pixel basis by the action of local electric fields on the birefringence of the liquid crystal in accordance with a display signal applied via the control electrodes. The light of altered polarization is then passed by the PBS to the projection optics.

In conventional systems the PBS is usually of the MacNeille prism type which is prone to stress-birefringence, due to stresses arising from differential thermal expansion of regions heated and unheated by the illuminating beam, exacerbated by the relatively large dimensions of the PBS which make temperature uniformity difficult to achieve and which lead to development of noticeable levels of optical retardance. Although the physical effect can be slight, on the order of nanometers or tens of nanometers, the optical consequences are clearly visible as alterations in the polarization state of the light, leading to non-uniformities in the output. The effect is especially noticeable in the dark state, showing up as lighter patches on a nominally black display screen.

The problem may be overcome by replacing much of the glass in the prism with a liquid, which does not exhibit stress-birefringence and allows temperature gradients to be homogenized by convection. A simpler solution is to use a wire-grid polarizing beam splitter of the type described in U.S. Pat. No. 6,243,199. Such a beam splitter has a parallel array of thin, elongated elements spaced on the order of wavelengths of visible light on a transparent substrate, which array interacts with waves of the incident light to transmit light of one polarization and reflect light of the other polarization. The device is to a first approximation an optical analog of polarizers for microwave radiation which are, in fact, arrays of wires spaced on the order of the microwave wavelengths.

When the wire grid is formed of finely-spaced aluminum lines on a glass substrate by photolithographic techniques, reflective liquid crystal display devices using the wire-grid polarizing beam splitter are capable of producing display images of higher contrast than systems using the conventional PBS of the MacNeille prism type, due at least in part to the freedom of the wire-grid polarizer from stress-birefringence.

Unfortunately, the aluminum wire-grid polarizer is unstable in normal ambient atmospheres over expected projector lifetimes, due to the susceptibility of the very thin—on the order of 200 nm—lines of pure aluminum to corrosion by contact with even trace amounts of reactive atmospheric components. Oxygen and water vapor are expected to be the principal sources of degradation, but other species in the environment are also likely to be a problem, particularly sulfur compounds relatively abundant in urban atmospheres. The wire grid must also be protected from handling, such as may occur in projector assembly, service, etc.

Due to the very delicate nature of the wire grid and the critical dependence of its structure on its optical properties, a satisfactory protective coating has not yet been developed. Thus, the excellent performance characteristics of this type of PBS are subject to significant degradation over time, preventing use of this type of PBS in a commercial display system.

In accordance with the invention, the wire-grid polarization beam splitter is sealed in an enclosure having a non-reactive atmosphere such as an inert gas, nitrogen or vacuum.

The enclosure may advantageously be a housing which also supports other optical components such as the light modulator panel and one or more lenses of a liquid crystal display system. Such a housing may have faces with mounting apertures into which the PBS and other optical components are sealed. This arrangement eliminates the need for separate mounts for the polarizer, the panel and the lenses, and is advantageously used as a last-stage sub-assembly for a liquid crystal display system for data display, cinema, or television.

According to one aspect of the invention, a light polarizing device comprises a polarizing element having an optically transparent substrate, an environmentally sensitive polarizing element such as a wire-grid polarizing element on the substrate, and a sealed enclosure surrounding the polarizing element, the enclosure maintaining a non-reactive atmosphere to protect the polarizing element from the ambient environment.

According to another aspect of the invention, a light polarizing device comprises an optically transparent substrate, an environmentally sensitive polarizing element on the substrate, an optically transparent cover sheet, a plurality of spacers distributed around the periphery of the substrate and supporting the cover sheet spaced above the element, a sealant extending around the periphery of the device between the substrate and the cover sheet, and a non-reactive atmosphere filling the interior space between the substrate and the cover sheet and protecting the environmentally sensitive polarizing element.

According to a third aspect of the invention, there is provided a sealable housing for use in a sub-assembly for a display device, the sealable housing comprising a plurality of mounting apertures for optical elements.

Advantageously, the sealable housing is a wedge-shaped enclosure having three face portions extending between triangular top and bottom portions, each face having a mounting aperture for an optical element or device.

According to yet another aspect of the invention, an environmentally sensitive polarizing device, a light modulator panel and a lens are sealed into the sealable housing to form a sub-assembly for a display device.

### BRIEF DESCRIPTION OF THE DRAWING

FIGS. 1A and 1B are diagrammatic cross-sectional views of an environmentally-sensitive polarizing device of the Prior Art and one embodiment of an enclosed polarizing device of the invention, respectively;

FIG. 2 is a diagrammatic cross-sectional view of another embodiment of an enclosed polarizing device of the invention;

FIG. 3 is a perspective view of one embodiment of a sealable enclosure suitable for use in a light modulator sub-assembly for a display device; and

FIG. 4 is a section view of a light modulator sub-assembly using the enclosure of FIG. 3.

### DETAILED DESCRIPTION OF THE INVENTION

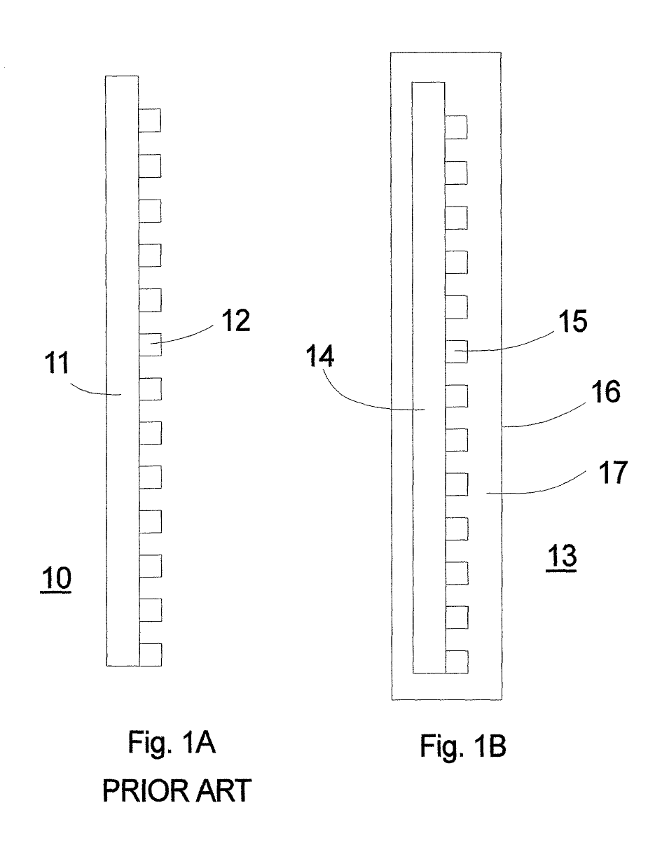

FIG. 1A shows diagrammatically in cross-section a wire-grid polarizer 10 of the prior art, such as the type described in U.S. Pat. No. 6,243,199, having an optically transparent substrate 11, for example, glass, supporting wire grid 12, composed of parallel lines of aluminum, typically having a thickness of about 200 nm and spacing of about 200 nm. Because the fine structure of this wire grid, reaction of the aluminum with the ambient can damage the grid structure, resulting in degradation of the operating characteristics of the polarizer.

FIG. 1B shows diagrammatically in cross-section one embodiment of an enclosed wire-grid polarizer 13 of the invention, having a transparent optical substrate 14 and a wire grid 15 on the substrate 14, surrounded by an enclosure 16. The enclosure is formed of a transparent material, such as glass, and is provided with a non-reactive atmosphere, such as a vacuum or an inert gas.

Aluminum is a preferred wire-grid material. It has high reflectivity and is compatible with standard semiconductor processing practices by which such devices are presently made. An alternative material to aluminum is silver, which also has high conductivity and reflectivity. Like aluminum, silver is environmentally sensitive, primarily to sulfur compounds present in the ambient, and requires the atmospheric protection offered by the invention.

Since only the wire grid need be protected from the environment, a satisfactory enclosure may also be provided by placing a transparent cover sheet on spacers located on the periphery of the substrate to separate the cover sheet slightly from the wire grid, sealing the cover sheet to the glass substrate, and evacuating the intervening space or filling it with an inert gas. This embodiment may be used advantageously in display devices using transmissive light modulators.

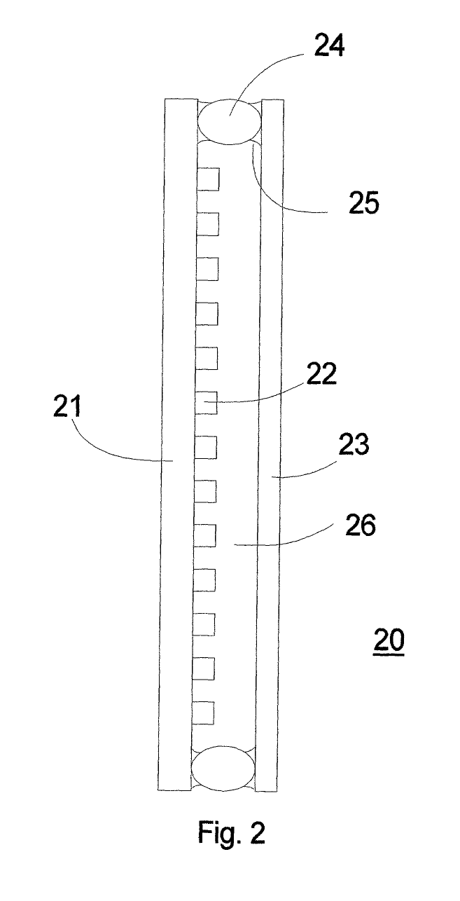

Such a structure is shown in FIG. 2, in which enclosed wire-grid polarizer 20 includes glass substrate 21, wire grid 22, glass cover sheet 23 resting on spacers 24 and sealed to substrate 21 with sealant 25. Sealant 25 may be of any sealant material sufficiently impermeable to the ambient and to the interior atmosphere 26, for example, room-temperature-vulcanizing silicone rubber or acrylic adhesives curable by UV light as typically used in optical assemblies.

Perfect hermeticity is not required, just sufficient isolation to prevent degradation of the wire-grid element over the expected lifetime of the optical system.

In an optical device or system employing the wire-grid polarizer as one of several optical elements or devices, it may be advantageous to incorporate two or more of these elements or devices into an integral sealable housing. The sealable housing provides an enclosure for the protective environment required by the wire-grid polarizer, and also eliminates the need to mount the various elements or devices individually.

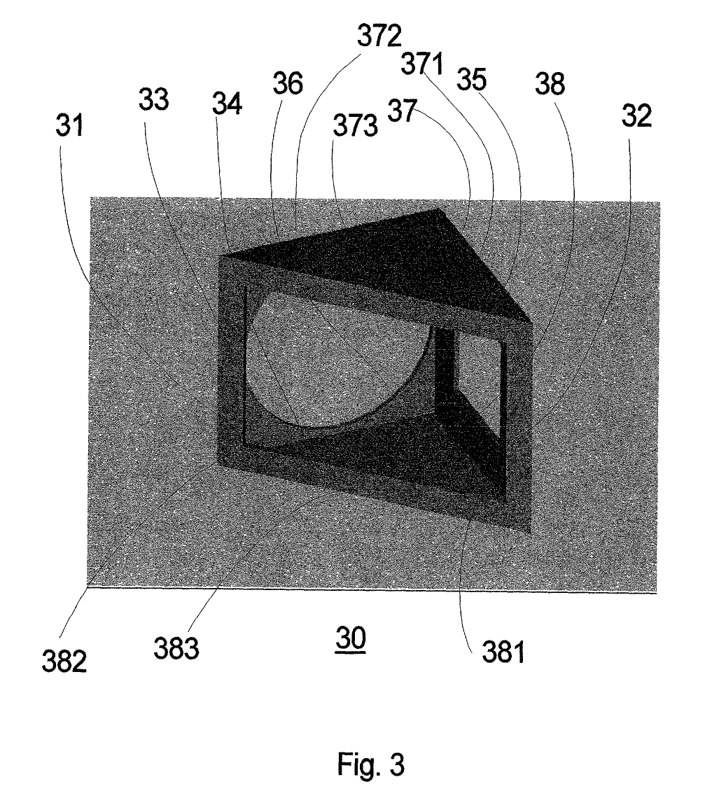

One embodiment of such an integral sealable housing 30 suitable for use as a last-stage sub-assembly for a liquid crystal projection display system is shown in perspective in FIG. 3.

The wedge-shaped housing has three rectangular faces 31, 32 and 33, each having a mounting aperture 34, 35, 36. The three faces extend between top and bottom portions 37 and 38, each having the shape of a right-triangle with two short sides (371, 372) and (381, 382) and one long side (373, 383) respectively. Face 31 extends between sides 373 and 383, corresponding to the hypotenuses of the wedge-shaped enclosure 30, and has aperture 34, sized to fit a wire-grid polarizer with the active surface facing inward. Face 32 extends between sides 371 and 381, and has an aperture 35 sized to fit a reflective liquid crystal light modulator panel, also with the active surface facing inward. Face 33 extends between short sides 372 and 382, and has an aperture 36 sized to fit a projection lens.

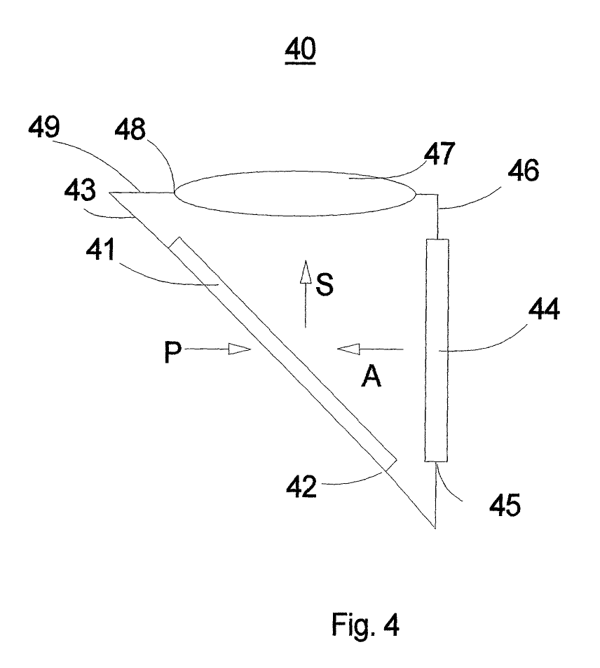

Such an integral housing with elements and devices in place to form a light modulator sub-assembly 40 for a reflective liquid crystal projection display system is shown in section view in FIG. 4. Wire-grid polarizer 41 is sealed into aperture 42 of side 43; a liquid crystal on silicon (LCoS) light modulator panel 44 is sealed into aperture 45 of side 46; and projection lens 47 is sealed into aperture 48 of side 49. The interior of the sealed housing has a non-reactive atmosphere, e.g., nitrogen or an inert gas, or a vacuum.

In one possible mode of operation, P polarized light, represented by arrow P, enters through polarizer 41 and is incident on light modulator panel 44. The polarization of the incident light is altered on a pixel-by-pixel basis by the liquid crystal layer above the reflective pixel array in accordance with a display signal applied to the reflective array. The light modulator panel 44 includes a quarter wave retarder to convert incoming linearly polarized light into circularly polarized light and back into partially linearly polarized light after reflection from the light modulator and modification by the liquid crystal layer in the display device before being passed to the projection lens 47.

The altered light, represented by arrow A, is reflected by the panel 44 back to the polarizer 41, where only light of one linear polarization state, represented by arrow S, is reflected to the projection lens 47.

The enclosure may include some means of pressure relief such as a flexible diaphragm should operating temperatures be so high that gas expansion is of concern, although for most systems this will be unlikely. The enclosure material should be dimensionally stable to retain the required optical tolerances, and could be an injection molded glass-filled polymer of the type used in many commercial projection systems. The optical elements may be sealed with conventional adhesives normally used for optical assembly.

The light modulator sub-assembly of FIG. 4 using the housing of FIG. 3 operates in the transmission-reflection (‘T-R’) mode, wherein the beam from a light engine is transmitted by the polarization device to the panel, and the light modulated by the panel is reflected from the polarization device to a display screen via the projection lens. The sub-assembly of FIG. 4 may also operate in the reflection-transmission (‘R-T’) mode, wherein the incoming beam from a light engine enters through the lens, which in this mode the last element of a light engine. The beam is then reflected by the polarization device to the panel, and the modulated light from the panel is transmitted by the polarization device to a projection lens outside the sub-assembly.

Although unnecessary to an understanding of the present invention, a description of a reflective liquid crystal display device may be found in U.S. Pat. No. 6,307,607, issued to Jepsen et al. on Oct. 23, 2001; a liquid crystal display system employing scrolling color beams on a single panel to produce a full color display is described in U.S. Pat. No. 5,999,321, issued to Bradley on Dec. 7, 1999. The specification of both patents is incorporated herein by reference.

In addition to their use in projectors incorporating reflective light modulators, such protected wire-grid polarizer elements can be advantageously used in projectors incorporating transmissive liquid crystal light valves. The enclosure embodiment shown in FIG. 2 may advantageously be used as a pre-polarizer with or without a polarization conversion system such as presently employed in many commercial projection systems.

The invention has necessarily been described in terms of a limited number of embodiments. From this description, other embodiments and variations of embodiments will become apparent to those skilled in the art, and are intended to be fully encompassed within the scope of the invention and the appended claims.

What I claim as my invention is:

1. A light polarizing device comprising:
a polarizing element having an optically transparent substrate, an environmentally sensitive polarizing element on the substrate, and a sealed enclosure surrounding the polarizing element, the enclosure having a non-reactive atmosphere to protect the polarizing element from the ambient environment.

2. The light polarizing device of claim 1 in which the polarizing element is a wire-grid polarizing element.

3. A light polarizing device comprising:
an optically transparent substrate, an environmentally sensitive polarizing element on the substrate, an optically transparent cover sheet, a plurality of spacers distributed around the periphery of the device and supporting the cover sheet on the substrate above the element, sealant extending around the periphery of the device between the substrate and the cover sheet, and non-reactive atmosphere filling the interior space between the substrate and the cover sheet and protecting the environmentally sensitive polarizing element.

4. The light polarizing device of claim 3 in which the polarizing element is a wire-grid polarizing element.

5. A sealable housing for use in a sub-assembly for a display device, the sealable housing comprising mounting apertures for optical elements.

6. The sealable housing of claim 5 comprised of triangular top and bottom portions and three face portions extending between the top and bottom portions to form a wedge-shaped enclosure, one of the mounting apertures for optical elements located in each of the face portions.

7. The sealable housing of claim 6 in which the top and bottom portions are right triangles each having two short sides and a long side, respectively.

8. A sub-assembly for a display device comprising a sealable housing 40 having first, second and third mounting apertures, a light polarizing element having an environmentally sensitive active surface, the light polarizing element sealed into the first aperture, a light modulator panel sealed into the second aperture and a lens sealed into the third aperture.

9. The sub-assembly of claim 8 in which the sealable housing comprises triangular top and bottom portions and first, second and third rectangular face portions extending between the top and bottom portions to form a wedge-shaped enclosure, the first, second and third mounting apertures being located in the first, second and third rectangular face portions, respectively.

10. The sub-assembly of claim 9 in which the top and bottom portions are right-triangles having two short sides and a long side, and the first face portion extends between the long sides of the top and bottom portions.

11. The sub-assembly of claim 10 in which the polarizing element is a wire-grid polarizer.

12. The sub-assembly of claim 8 in which the light modulator panel is a reflective liquid crystal light modulator panel.

13. The sub-assembly of claim 8 in which the lens is a projection lens.
